(19) United States
(12) Patent Application Publication
(10) Pub. No.: US 2014/0314655 A1
(43) Pub. Date: Oct. 23, 2014

(54) CORROSION AND FOULING REDUCTION IN HYDROCHLOROSILANE PRODUCTION

(71) Applicant: REC Silicon Inc, Moses Lake, WA (US)

(72) Inventors: Stein Julsrud, Moses Lake, WA (US); Anja Olafsen Sjastad, Oslo (NO)

(73) Assignee: REC Silicon Inc, Moses Lake, WA (US)

(21) Appl. No.: 14/243,822

(22) Filed: Apr. 2, 2014

Related U.S. Application Data
(60) Provisional application No. 61/814,127, filed on Apr. 19, 2013.

(51) Int. Cl. C01B 33/107

(52) U.S. Cl. CPC C01B 33/1071
USPC 423/342

(57) ABSTRACT

Methods for reducing iron silicide and/or iron phosphide fouling and/or corrosion in a hydrochlorosilane production plant are disclosed. Sufficient hydrogen is added to a silicon tetrachloride process stream to inhibit iron (II) chloride formation and reduce iron suicide and/or iron phosphide fouling, superheater corrosion, or a combination thereof. Trichlorosilane also may be added to the silicon tetrachloride process stream.

### CROSS REFERENCE TO RELATED APPLICATION

This claims the benefit of U.S. Provisional Application No. 61/814,127, filed Apr. 19, 2013, which is incorporated in its entirety herein by reference.

### FIELD

This disclosure concerns a method for reducing corrosion and/or fouling in hydrohalosilane production plants.

### SUMMARY

A hydrohalosilane production plant includes components such as vessels (e.g., a silicon tetrahalide superheater and a hydrogenation reactor) and conduits for transporting liquid and/or vapor streams to and from the vessels. One or more production plant components may include iron. Additionally, silicon feedstock may include a trace amount of iron. Iron silicide fouling and corrosion in the hydrohalosilane production plant is reduced by including a sufficient concentration of hydrogen in a silicon tetrahalide process stream to inhibit iron halide formation and reduce superheater corrosion, iron silicide and/or iron phosphide fouling of production plant components (e.g., the hydrogenation reactor), or a combination thereof.

In one embodiment, the production plant is a hydrochlorosilane production plant, and the method includes adding hydrogen to a vaporized silicon tetrachloride process stream upstream of a silicon tetrachloride (STC) superheater to form a combined hydrogen/silicon tetrachloride feed having a concentration of hydrogen sufficient to inhibit FeCl₂ vapor formation in the STC superheater, thereby reducing iron silicide and/or iron phosphide fouling, superheater corrosion, or a combination thereof, and flowing the combined H₂/STC feed into the silicon tetrachloride superheater. In some instances, the combined H₂/STC feed has a hydrogen mole fraction of at least 0.4, such as a hydrogen mole fraction from 0.4 to 0.9. In certain arrangements, hydrogen is added to the vaporized silicon tetrachloride process stream in an amount sufficient to produce a H₂/SiCl₄ mole ratio of at least 0.67:1, such as from 0.67:1 to 5:1, in the combined H₂/STC feed.

The method may further include adding trichlorosilane (TCS) to the silicon tetrachloride process stream before flowing the combined H₂/STC feed into the STC superheater. TCS may be added to the combined H₂/STC feed to provide a TCS concentration of 0.05 mol % to 2 mol %, such as from 0.5 mol % to 1.5 mol %. When the TCS concentration is at least 0.5 mol %, the hydrogen mole fraction may be 0.05 or greater.

The foregoing and other objects, features, and advantages of the invention will become more apparent from the following detailed description, which proceeds with reference to the accompanying figures.

### BRIEF DESCRIPTION OF THE DRAWINGS

FIG. 1 is a schematic flow diagram of a hydrochlorosilane production plant.

FIG. 2 is a graph of HCl partial pressure versus H₂ mole fraction illustrating the FeCl₂-FeSi transition as the H₂/SiCl₄ ratio, HCl partial pressure, and trichlorosilane content vary.

### DETAILED DESCRIPTION

Silicon tetrahalides (e.g., silicon tetrachloride) are hydrogenated to produce hydrohalosilanes and silanes. See, e.g., U.S. Pat. No. 4,676,967 and International Publication No. WO 2006/098722. A hydrohalosilane production plant comprises components including vessels, such as a silicon tetrahalide superheater and a hydrogenation reactor, and conduits for transporting liquid and/or vapor streams to and from the vessels. Alloys used in the construction of the production plant components typically are iron-based. Iron also may be present as a trace element (e.g., less than 1% (w/w), or less than 0.1% (w/w)) in silicon feedstock used in the production plant.

The temperature in a silicon tetrahalide superheater is sufficient to produce significant vapor pressures of iron halides when the activity of halides is high. For example, in a silicon tetrachloride superheater, significant iron (II) chloride vapor pressures are produced at typical operating temperatures.

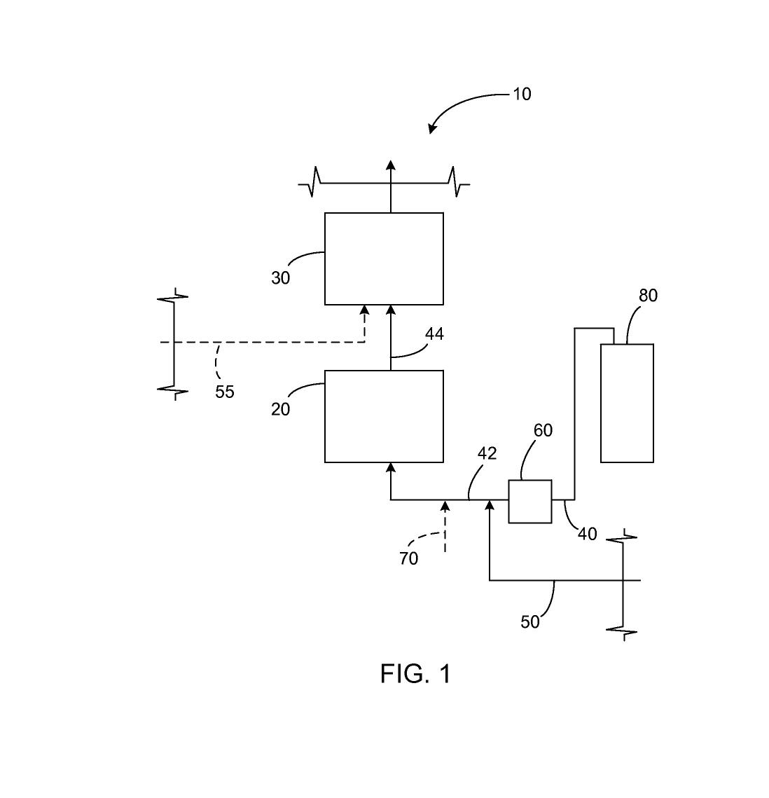

With reference to FIG. 1, a hydrochlorosilane production plant 10 comprises a silicon tetrachloride (STC) superheater 20 and a hydrogenation reactor 30. If a silicon tetrachloride process stream 40 is pure or includes any HCl, FeCl₂ vapor is produced when iron in the superheater walls reacts with chloride ions. Iron also may be present in the STC process stream 40 when STC is made from silicon feedstock including a trace amount of iron. The STC process stream 40 further may include trace amounts of hydrogen. In the STC superheater 20, STC reacts with hydrogen to produce trichlorosilane and hydrogen chloride.

SiCl_{4(g)}+H_{2(g)} [symbol] _{HSiCl}_{3(g)}+HCl_{(g)} (1)

Hydrogen chloride can react with iron present in the STC feed and/or in iron alloys within the superheater 20 to produce iron (II) chloride.

2 HCl_{(g)}+Fe(s)→FeCl₂₍ₛ₎+H_{2(g)} (2)

Under some conditions, iron (II) chloride reacts with STC and hydrogen to produce iron silicide.

SiCl_{4(g)}+FeCl₂₍ₛ₎+3 H_{2(g)} [symbol] FeSi₍ₛ₎+6 HCl_{(g)} (3)

Iron silicide deposits in the superheater 20 and can form a passivating later on the superheater walls, thereby suppressing subsequent iron (II) chloride formation over time.

However, in the presence of excess HCl and/or insufficient hydrogen, the equilibrium in equation (3) shifts to the left, increasing the concentration of FeCl₂ in the superheater 20. FeCl₂ has a significant vapor pressure at the operating temperature in the superheater 20. Thus, as the amount of FeCl₂ increases, the concentration of FeCl₂ vapor also increases. The FeCl₂ vapor then is transported with the superheated process stream 44 to other areas of the production plant. For example, the FeCl₂ vapor may be transported with the superheated process stream 44 to a distributor plate area in a hydrogenation reactor 30 where iron silicides and/or phosphides (if phosphine or other phosphorus-based compounds are present in the process stream) can form in the hydrogenation reactor 30. Deposition of iron silicides and/or phosphides leads to fouling of the distributor orifices and disruption of production runs. Formation of FeCl₂ vapor also causes corrosion of the superheater 20. To a lesser extent, high chloride activities may lead to transport of other alloy elements besides iron. Over the long term, such materials transport and the resulting fouling and/or corrosion may reduce the lifetime of the silicon tetrachloride superheater 20 and/or the hydrogenation reactor 30.

Fouling and/or corrosion are inhibited or prevented by minimizing the formation of iron (II) chloride. Combining hydrogen with the STC process stream drives the equilibrium in equation (3) to the right, thereby favoring FeSi formation and minimizing or preventing FeCl₂ formation. Desirably, hydrogen 50 is added to the STC process stream 40 before entering the silicon tetrachloride superheater 20. The combined H₂/STC feed 42 then flows into the superheater 20. The STC process stream 40 may be heated to vaporize STC before introducing hydrogen so that hydrogen 50 is added to a vaporized STC process stream 40 upstream of the silicon tetrachloride superheater 20. Any suitable heater 60, such as a heat exchanger (e.g., a shell-and-tube heat exchanger), can be used to vaporize the STC process stream 40. In some arrangements, hydrogen 50 is introduced at a temperature less than or equal to the STC vapor temperature. Optionally, the combined H₂/STC feed 42 may flow through another heat exchanger (not shown) to increase the combined feed temperature prior to entering the superheater 20.

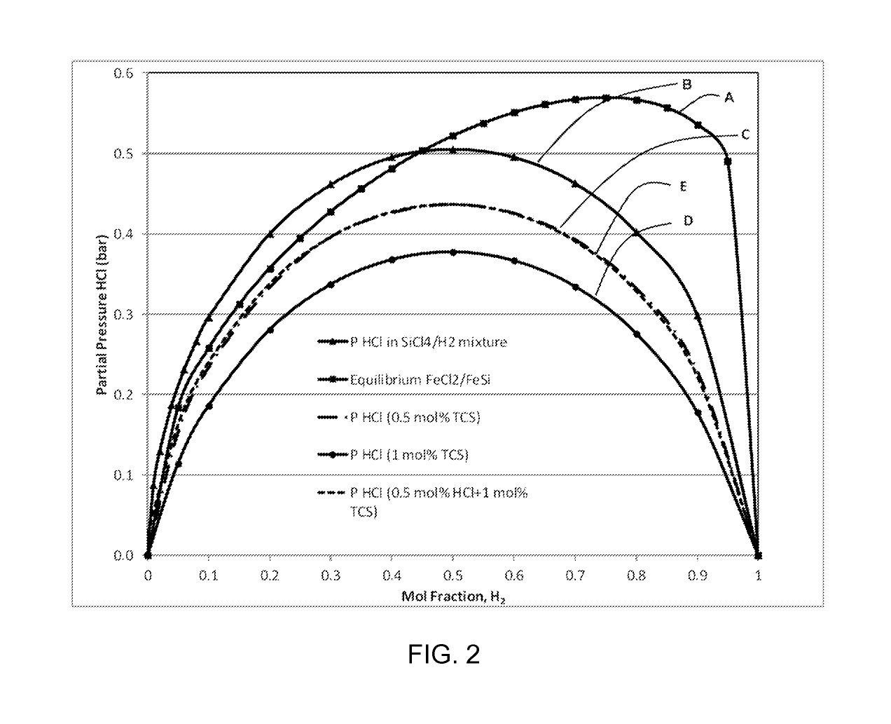

FIG. 2 is a graph illustrating the relationship between FeCl₂ and FeSi during the reaction shown in equation (3), with regard to the H₂/SiCl₄ ratio, HCl content, and TCS content of the process stream. The data in FIG. 2 was obtained at a total pressure of 30 bar, and a temperature of 823K. With reference to FIG. 2, curve A indicates the division between FeCl₂ and FeSi phases within the superheater. At a given H₂ fraction, if the HCl partial pressure is above curve A, FeCl₂ predominates. If the HCl partial pressure is below curve A, FeSi predominates. Curve B represents the partial pressure of HCl in a STC/H₂ mixture as a function of the H₂ fraction. For example, when the H₂ fraction is 0.1, the partial pressure of HCl is ˜0.3; when the H₂ fraction is 0.7, the partial pressure of HCl is ˜0.45. Fouling and/or corrosion are reduced or eliminated by maintaining reaction conditions such that the HCl partial pressure curve (e.g., curve B) is below curve A. Under conditions where the HCl partial pressure curve is below curve A, there is less HCl available to react with iron in the superheater alloys (equation (2)), and the equilibrium in equation (3) also is shifted to the right, favoring FeSi formation over FeCl₂ formation. As shown in FIG. 2, whenever the H₂ fraction is less than 0.4, curve B (the partial pressure of HCl) is above curve A, indicating undesirable operating conditions. When the H₂ fraction is at least 0.4, curve B is below curve A and desirable operating conditions are achieved. Desirable operating conditions are conditions under which corrosion and/or fouling is inhibited by at least 50%, at least 70%, at least 90%, at least 95%, at least 98%, 50-100%, 50-98%, 50-95%, 50-90%, 50-70%, 70-100%, 70-98%, 70-95%, 70-90%, 90-100%, 90-98%, or 90-95% compared to operating under conditions that favor FeCl₂ formation.

Thus, favorable results are achieved when a combined H₂/STC feed has a hydrogen mole fraction of at least 0.4, particularly at a hydrogen mole fraction from 0.4 to 0.9, or from 0.4 to 0.65. In certain examples, the hydrogen mole fraction is 0.5. Stated otherwise, hydrogen may be combined with STC at a H₂:SiCl₄ mole ratio of at least 0.67:1, such as a mole ratio of from 0.67:1 to 5:1, from 0.67:1 to 3:1, from 0.67:1 to 2:1, from 1:1 to 2:1, or a mole ratio from 1:1 to 1.8:1. Ideally, the H₂:SiCl₄ mole ratio is 1:1. Theoretically there is no upper limit on the hydrogen concentration so long as at least some STC is present. However, from a practical standpoint, a person of ordinary skill in the art understands that as the concentration of hydrogen increases, the relative amount of STC in the process stream decreases, thereby decreasing the overall yield of hydrochlorosilanes produced in the hydrogenation reactor.

Hydrogen stream 50 may be the primary or sole source of hydrogen for the hydrogenation reaction. In some arrangements, hydrogen stream 50 provides only a portion of the hydrogen for the hydrogenation reaction, and additional hydrogen 55 may be provided directly to the hydrogenation reactor 30. If additional hydrogen 55 is provided, the hydrogen is preheated to a temperature substantially similar to superheated process stream 44.

Trichlorosilane (TCS) also can be added to the STC process stream. TCS reduces the activity of the chlorides while increasing the activity of silicides in the STC superheater (and other places in the process stream), thereby reducing or preventing fouling. TCS in the STC process stream reacts with HCl and reduces the HCl partial pressure.

HSiCl_{3(g)}+HCl_{(g)}→SiCl_{4(g)}+H_{2(g)} (4)

Reduction of HCl in turn reduces the extent of the reaction in equation (2) and shifts the equilibrium in equation (3) to the right, thereby reducing the amount of FeCl₂ produced or even preventing FeCl₂ formation.

As shown in FIG. 2, providing TCS lowers the HCl partial pressure as TCS reacts with HCl (equation (4)). For example, when 0.5 mol % TCS is added to the superheater, the HCl partial pressure is represented by curve C. Addition of 0.5 mol % TCS lowers the entire HCl partial pressure curve relative to curve B. At hydrogen fractions from 0.2-1, curve C is below curve A and operating conditions are favorable for minimizing or preventing FeCl₂ formation. Increasing TCS to 1 mol % lowers the partial pressure of HCl even further as demonstrated by curve D. Thus, a lesser amount of H₂ may be added to the STC process stream when TCS is present. TCS may be obtained by recycling a portion of the product exiting the hydrogenation reactor 30. However, recycling TCS will at least slightly reduce the yield of the hydrogenation process. Furthermore, if TCS is obtained by recycling, additional energy will be used during the overall process.

TCS may be added as a separate component to STC process stream 40 or the combined H₂/STC feed 42 upstream of the superheater 20, as shown at 70 in FIG. 1, or between the superheater 20 and the hydrogenation reactor 30. TCS can be added to provide a TCS concentration of 0.05 mol % to 2 mol %., such as a concentration of 0.1 mol % to 2 mol %, 0.1 mol % to 1.5 mol %, 0.2 mol % to 1.5 mol %, or 0.5 mol % to 1.5 mol %. When the TCS concentration is 0.5-1.5 mol %, the combined H₂/STC feed may have a hydrogen mole fraction of at least 0.05, particularly a hydrogen mole fraction from 0.05 to 0.9, or 0.1 to 0.7. In some arrangements, a desired level of TCS can be maintained in the STC process stream by varying conditions in an STC distillation column 80 such that the STC distillate includes the desired level of TCS.

A method for reducing iron silicide and/or iron phosphide fouling and/or corrosion in a hydrochlorosilane production plant comprising a silicon tetrachloride superheater and a hydrogenation reactor includes adding hydrogen to a vaporized silicon tetrachloride process stream upstream of the silicon tetrachloride superheater to form a combined hydrogen/silicon tetrachloride feed having a concentration of hydrogen sufficient to inhibit FeCl₂ vapor formation in the silicon tetrachloride superheater, thereby reducing iron silicide and/or iron phosphide fouling, superheater corrosion, or a combination thereof; flowing the combined hydrogen/silicon tetrachloride feed into the silicon tetrachloride superheater; and subsequently flowing the combined hydrogen/silicon tetrachloride feed into the hydrogenation reactor. The combined hydrogen silicon tetrachloride feed may have a hydrogen mole fraction of at least 0.4, such as from 0.4 to 0.9.

In any or all of the above embodiments, hydrogen may be added to the vaporized silicon tetrachloride process stream in an amount sufficient to produce a H₂/SiCl₄ mole ratio of at least 0.67:1 in the combined hydrogen/silicon tetrachloride feed. In one embodiment, the H₂/SiCl₄ mole ratio is from 0.67:1 to 5:1. In another embodiment, the H₂/SiCl₄ mole ratio is 1:1.

In any or all of the above embodiments, hydrogen may be added to the silicon tetrachloride process stream in an amount sufficient to inhibit superheater corrosion. In any or all of the above embodiments, hydrogen may be added to the silicon tetrachloride process stream in an amount sufficient to inhibit iron silicide fouling, iron phosphide fouling, or a combination thereof in the hydrogenation reactor.

In any or all of the above embodiments, the method may further include adding trichlorosilane to the silicon tetrachloride process stream before flowing the combined hydrogen/silicon tetrachloride feed into the silicon tetrachloride superheater. In some embodiments, the trichlorosilane is added to the silicon tetrachloride process stream after the hydrogen has been added. In any or all of the foregoing embodiments, trichlorosilane may be added to the combined hydrogen/silicon tetrachloride feed in an amount sufficient to provide a trichlorosilane concentration of 0.05 mol % to 2 mol %, such as 0.5 mol % to 1.5 mol %. When the trichlorosilane concentration is 0.5 mol % to 1.5 mol %, the combined hydrogen/silicon tetrachloride feed may have a hydrogen mole fraction of at least 0.05.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope and spirit of these claims.

We claim:

1. A method for reducing iron silicide and/or iron phosphide fouling and/or corrosion in a hydrochlorosilane production plant comprising a silicon tetrachloride superheater and a hydrogenation reactor, the method comprising:
adding hydrogen to a vaporized silicon tetrachloride process stream upstream of the silicon tetrachloride superheater to form a combined hydrogen/silicon tetrachloride feed having a concentration of hydrogen sufficient to inhibit FeCl₂ vapor formation in the silicon tetrachloride superheater, thereby reducing iron silicide and/or iron phosphide fouling, superheater corrosion, or a combination thereof; and
flowing the combined hydrogen/silicon tetrachloride feed into the silicon tetrachloride superheater; and
subsequently flowing the combined hydrogen/silicon tetrachloride feed into the hydrogenation reactor.

2. The method of claim 1, wherein the combined hydrogen/silicon tetrachloride feed has a hydrogen mole fraction of at least 0.4.

3. The method of claim 2, wherein the hydrogen mole fraction is from 0.4 to 0.9.

4. The method of claim 1, wherein hydrogen is added to the vaporized silicon tetrachloride process stream in an amount sufficient to produce a H₂/SiCl₄ mole ratio of at least 0.67:1 in the combined hydrogen/silicon tetrachloride feed.

5. The method of claim 4, wherein the H₂/SiCl₄ mole ratio is from 0.67:1 to 5:1.

6. The method of claim 4, wherein the H₂/SiCl₄ mole ratio is 1:1.

7. The method of claim 1, wherein hydrogen is added to the silicon tetrachloride process stream in an amount sufficient to inhibit superheater corrosion.

8. The method of claim 1, wherein hydrogen is added to the silicon tetrachloride process stream in an amount sufficient to inhibit iron silicide fouling, iron phosphide fouling, or a combination thereof in the hydrogenation reactor.

9. The method of claim 1, further comprising adding trichlorosilane to the silicon tetrachloride process stream before flowing the combined hydrogen/silicon tetrachloride feed into the silicon tetrachloride superheater.

10. The method of claim 9, wherein the trichlorosilane is added to the silicon tetrachloride process stream after the hydrogen has been added.

11. The method of claim 9, wherein trichlorosilane is added to the combined hydrogen/silicon tetrachloride feed in an amount sufficient to provide a trichlorosilane concentration of 0.05 mol % to 2 mol %.

12. The method of claim 11, wherein the trichlorosilane concentration is 0.5 mol % to 1.5 mol %.

13. The method of claim 12, wherein the combined hydrogen/silicon tetrachloride feed has a hydrogen mole fraction of at least 0.05.
